(19) United States
(12) Patent Application Publication
(10) Pub. No.: US 2020/0042969 A1
(43) Pub. Date: Feb. 6, 2020

(54) VENDING MACHINES AND METHODS FOR DISPENSING PRODUCTS

(71) Applicant: SAVIS RETAIL PVT. LTD., Bangalore (IN)

(72) Inventor: Neeraj RAY, Bangalore (IN)

(21) Appl. No.: 16/339,971

(22) PCT Filed: Oct. 5, 2017
(86) PCT No.: PCT/IB2017/056149

§ 371 Date: Apr. 5, 2019

(30) Foreign Application Priority Data
Oct. 5, 2016 (IN) 201641034130

(51) Int. Cl. G06Q 20/18; G06Q 20/40; G06Q 20/32; G06Q 20/24; G07F 9/02; G07F 9/10; G07F 11/40; G07F 11/04

(52) U.S. Cl. CPC G06Q 20/18; G06Q 20/401; G06Q 20/325; G07F 11/04; G07F 9/026; G07F 9/10; G07F 11/40; G06Q 20/24

(57) ABSTRACT

The present invention relates to use of vending machines for dispensing or effecting automated sales of products. In particular, the invention is directed towards vending machines, methods of dispensing products from such vending machines, and methods for effecting payment for products or articles dispensed by a vending machine. In an embodiment, the vending machine comprises (i) a vending machine cabinet, (ii) at least one horizontally oriented partition chassis, wherein the partition chassis comprises a base plate, a plurality of partition trays independently mounted on said base plate and a plurality of load sensors, (iii) at least one door having a selectively actuatable lock, and (iv) a controller.

### FIELD OF THE INVENTION

The present invention relates to use of vending machines for dispensing or effecting automated sales of products. In particular, the invention is directed towards vending machines, methods of dispensing products from such vending machines, and methods for effecting payment for products or articles dispensed by a vending machine.

### BACKGROUND

Conventional vending machines typically incorporate complex product selection, payment and dispensing mechanisms to enable purchasers to view and select a product, allow users to make payment by cash or card, dispense change, and deliver the product in a way that prevents the purchaser from accessing the entire product inventory. Incorporation of each of these mechanisms into a vending machine makes the machine expensive, bulky and complicated to use. Additionally, the incorporation of multiple diverse hardware elements significantly increases the cost of manufacture of such vending machines, while simultaneously reducing available space for product inventory.

The process of identifying a product from the product display, entering a product selection, making payment and retrieving the dispensed article tends to involve multiple steps which the busy user would prefer to avoid. Additionally, users wanting to purchase multiple units of a products typically require to go through multiple iterations of some or all of these steps—leading to non-optimal user experience.

Further, purchasers require to rely on conventional payment instruments such as cash or electronic cards—which can often enough present a barrier to impulse purchases in situations where the purchaser is carrying neither cash nor card.

There is therefore a need for vending machines that simplify the user experience and present manufacturing and cost efficiencies, while simultaneously ensuring an efficient and secure payment system.

### SUMMARY

The invention is directed towards vending machines, methods of dispensing products from such vending machines, and methods for effecting payment for products or articles dispensed by a vending machine.

The invention provides a vending machine comprising a vending machine cabinet having an interior compartment, and at least one horizontally oriented partition chassis configured to sub-compartmentalize the interior compartment into a plurality of sub-compartments. The partition chassis may comprise (i) a base plate, (ii) a plurality of partition trays independently mounted on said base plate, wherein each partition tray is mounted on the base plate in contact isolation from all other partition trays mounted on said base plate, (iii) a plurality of load sensors, (iv) at least one door having a selectively actuatable lock (for example an electronically acutuatable lock or electronic lock), said door providing access to the at least one horizontally oriented partition chassis, and (v) a controller configured to determine weight of product(s) removed from a partition tray based on signals received from load sensors corresponding to said partition tray. In an embodiment, each load sensor corresponds uniquely to one partition tray mounted on the base plate, and further, each load sensor may be configured to detect and signal changes in load state associated with its corresponding partition tray.

In an embodiment of the vending machine, the controller may be communicably coupled with at least one of a remote server and a client device. The controller is configured to receive from either one of the remote server and the client device, one or more of (i) a product identifier corresponding to at least one product selected for purchase by a customer, (ii) identifier(s) corresponding to at least one partition chassis on which the selected product is stored or at least one partition tray on which the selected product is stored within the vending machine cabinet, (iii) identifier(s) corresponding to a vending machine door that controls access to a partition chassis or partition tray on which the selected product is stored within the vending machine cabinet, and (iv) code(s) authorizing unlocking of one or more vending machine doors that control access to a partition chassis or partition tray on which the selected product is stored within the vending machine cabinet.

The controller may also be configured to determine weight of product(s) removed from a partition tray, for each partition tray where load state changes have been detected by corresponding load sensors.

In an embodiment, the controller may be configured to determine a total price of product(s) removed by a customer based on (i) weight of product(s) removed from partition trays where load state changes have been detected, (ii) per-unit product weight associated with said partition trays, and (iii) per-unit product price associated with product types stored on said partition trays.

The total price of product(s) removed by a customer may be determined in response to a trigger event, said trigger event comprising any one of (i) receiving a signal confirming that a vending machine door has been closed, (ii) sending of a signal to re-engage door lock(s) for one or more vending machine doors, or (iii) receiving a signal confirming that locks for one or more vending machine doors have been re-engaged.

The invention additionally provides an automated product dispensing system comprising a remote server and a vending machine in accordance with any of the embodiments discussed above or hereinafter. The remote server and the controller may be communicably coupled to each other.

The remote server may be configured to record one or more of (i) a unique identifier corresponding to the vending machine, (ii) unique identifiers corresponding to each load sensor or each partition tray mounted within the at least one partition chassis, (iii) a correlation between each load sensor with a corresponding partition tray, (iv) a product type associated with each partition tray within the at least one partition chassis, (v) a per-unit product weight associated with each recorded product type, and (vi) a per-unit product price associated with each recorded product type.

In an embodiment of the automated product dispensing system, at least one of the remote server and the controller are configured for wireless communication with a client device. The controller may additionally be configured to receive from either one of the remote server and the client device, one or more of (i) a product identifier corresponding to at least one product selected for purchase by a customer, (ii) identifier(s) corresponding to at least one partition chassis on which the selected product is stored or at least one partition tray on which the selected product is stored within the vending machine cabinet, (iii) identifier(s) corresponding to a vending machine door that controls access to a partition chassis or partition tray on which the selected product is stored within the vending machine cabinet, and code(s) authorizing unlocking of one or more vending machine doors that control access to a partition chassis or partition tray on which the selected product is stored within the vending machine cabinet;

The controller may additionally be configured to determine weight of product(s) removed from a partition tray, for each partition tray where load state changes have been detected by corresponding load sensors.

In an embodiment of the automated product dispensing system, the remote server or the controller may be configured to determine a total price of product(s) removed by a customer based on (i) weight of product(s) removed from partition trays where load state changes have been detected, (ii) per-unit product weight associated with said partition trays, and (iii) per-unit product price associated with product types stored on said partition trays.

In a further embodiment of the automated product dispensing system the total price of product(s) removed by a customer may be determined in response to a trigger event. The trigger event may comprise any one of (i) receiving a signal confirming that a vending machine door has been closed, (ii) sending of a signal to re-engage door lock(s) for one or more vending machine doors, or (iii) receiving a signal confirming that locks for one or more vending machine doors have been re-engaged.

### BRIEF DESCRIPTION OF THE ACCOMPANYING DRAWINGS

FIG. 1 illustrates an external view of a vending machine in accordance with the present invention.

FIGS. 2, 3 and 4 illustrate embodiments of cabinets for a vending machine.

FIG. 5 illustrates a cabinet door for a vending machine.

FIG. 6 illustrates a partition chassis for a vending machine.

FIG. 7 shows a base plate of a vending machine partition chassis.

FIGS. 8 and 9 show partition tray plates of a partition chassis.

FIGS. 10, 11 and 13 illustrate exploded views of a partition chassis for a vending machine.

FIG. 12 illustrates an exemplary embodiment of a bracket that may be used to mount a partition tray onto a base plate within a partition chassis.

FIG. 14 is a communication flow diagram illustrating communications involved in operating a vending machine in accordance with the present invention.

FIG. 15 illustrates control components of a vending machine in accordance with the present invention.

FIGS. 16 and 17A to 17C hereafter describe methods for configuring and operating vending machines in accordance with teachings of the present invention.

FIG. 18 illustrates an exemplary computing system for implementing the present invention.

### DETAILED DESCRIPTION

The present invention provides novel and inventive vending machines and methods for purchasing and dispensing articles from such vending machines.

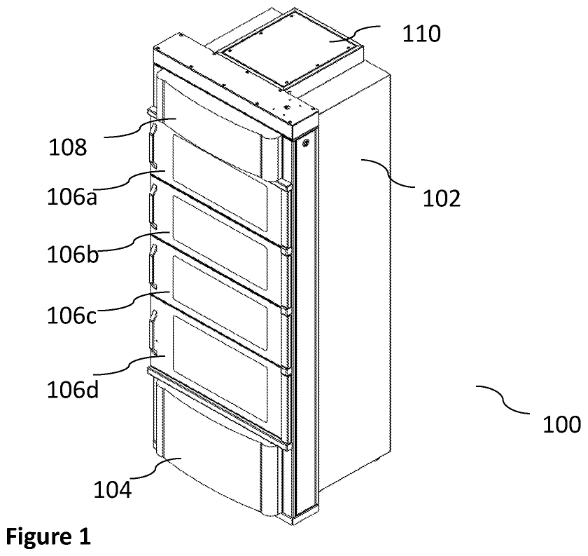

FIG. 1 illustrates an external view of a vending machine 100 manufactured and configured in accordance with the teachings of the present invention. Vending machine 100 comprises a cabinet 102 with an interior space for storage of articles. Cabinet 102 may optionally include (i) a compressor cabinet 104 for housing a compressor or other equipment for temperature and/or climate control within the vending machine and (ii) a control equipment access panel 110 which access panel enable access to control and communication components that are disposed within vending machine 100 for the purpose of operating the vending machine. Vending machine 100 is also shown with a plurality of doors 106a to 106d—each of which doors provides access to the interior space within cabinet 102. It will be understood that cabinet 102 may consist of either a single door, or multiple doors (as illustrated) depending on the specific configuration of the vending machine. In embodiments where the vending machine is provided with multiple doors, each door may permit access to a corresponding compartment or partitioned storage space within cabinet 102. Vending machine 100 may additionally include a display panel or signage panel 108 used to display signage or ads. In an embodiment, display panel 108 may comprise a CRT, LCD or plasma display.

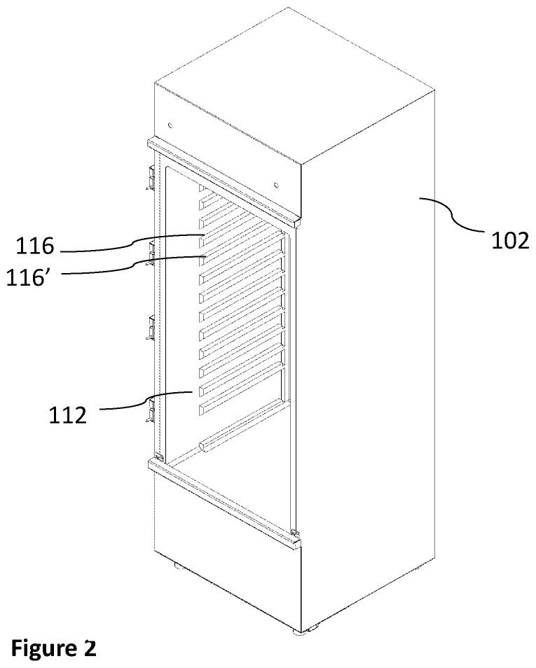

FIG. 2 illustrates an embodiment of cabinet 102. The vertical sidewalls and top and bottom walls of cabinet 102 define an interior compartment 112, which interior compartment may be used to house various components of vending machine 100, as well as articles that require to be dispensed by the vending machine. In the illustrated embodiment, internal surfaces of vertical sidewalls of cabinet 102 may be provided with support members 116, 116′ (which support members may comprise brackets, slots, lugs, grooves, raceways or other members) which are located and configured to enable shelves, trays or any other partitioning/storage members to be affixed within cabinet 102. In FIG. 2 support members 116, 116′ are only visible on an internal surface of a single vertical sidewall. However, it will be understood that corresponding support members may be provided on an internal surface of the opposite sidewall as well, and optionally on an internal surface of the rear vertical sidewall of cabinet 102 to enable affixing of shelves, trays, racks or partitioning members within interior compartment 112 of cabinet 102. Interior compartment 112 is accessible through the front side—which is an open side, and which may be configured to enable one or more doors to be mounted thereon.

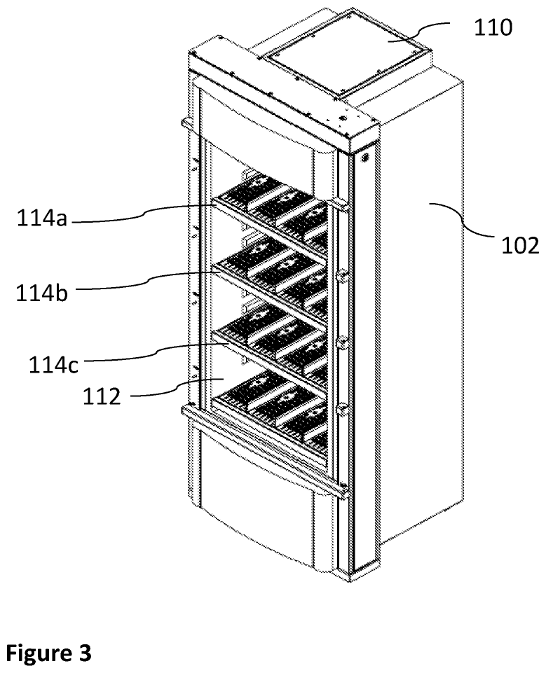

FIG. 3 illustrates an embodiment of cabinet 102 having at least one (and preferably a plurality of) horizontally oriented partitions (horizontal partitions) 114a to 114c mounted horizontally within interior compartment 112. In an embodiment of the invention, horizontal partitions 114a to 114c may comprise one or more shelves or trays that may be used to store articles intended to be dispensed from vending machine 100, which horizontal partition(s) may optionally be configured and sized such that affixing said horizontal partition(s) within cabinet 102 serves to partition or compartmentalize cabinet 102 into a plurality of sub-compartments. Embodiments of horizontal partitions 114a to 114c are described in more detail below.

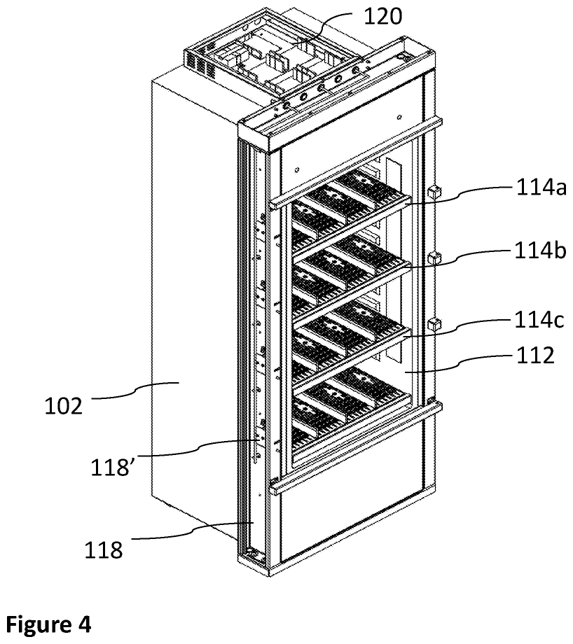

FIG. 4 illustrates an embodiment of cabinet 102 having a recessed channel 118 provided on an external surface of one sidewall, which recessed channel may be used to house one or more of door closure or door locking/unlocking mechanisms 118′, control and/or communication mechanisms and wiring for vending machine 100. It will be understood that similar recessed channels may optionally be provided on internal or external surfaces of other sidewalls of cabinet 102 as well. FIG. 4 also illustrates a recessed compartment 120 configured to house control and/or communication components necessary for operation of the vending machine. Recessed compartment 120 may be configured for closure by control equipment access panel 110 (shown in FIG. 1). Likewise recessed channel 118 may be configured for closure by one or more access panels.

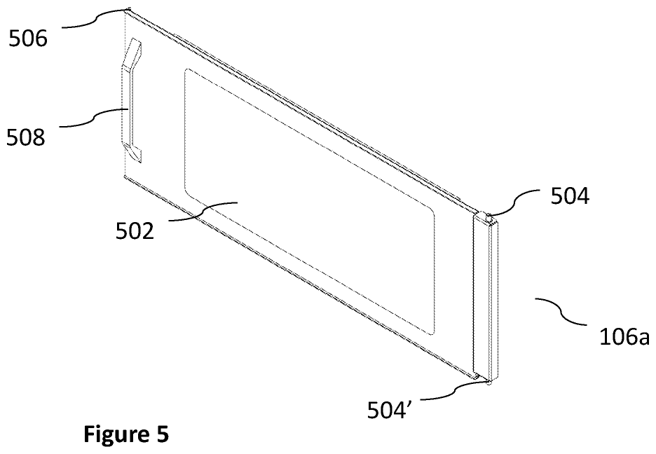

FIG. 5 illustrates an embodiment of a door 106a that may be mounted on cabinet 102 for closure. In the illustrated embodiment, door 106a comprises a door panel 502, hinge pins 504 and 504′, closure flange 506 and handle 508. Hinge pins 504 and 504′ are located and configured to enable mounting of door 106a on cabinet 102 in a manner that permits opening and closing of the door. In an embodiment of the invention, the hinged arrangement for mounting of door 106a on cabinet 102 may include an auto-close hinge. Closure flange 506 may comprise a flange configured such that, when the door is closed, closure flange 506 abuts against a vertical sidewall (or other portion) of cabinet 102—preferably in interference engagement or in locking arrangement with such vertical sidewall or other portion of cabinet 102—thereby enabling secure closure of cabinet 102. In the illustration of FIG. 5, door 106a is sized for closure of only a part of interior compartment 112—and multiple such doors would require to be mounted to fully control access to interior compartment 112. In other embodiments however, door 106a may be sized such that a single door serves as a closure for the entire interior compartment 112. In an embodiment of the vending machine, interior compartment 112 may be divided into multiple sub-compartments using shelves/horizontal partitions 114a to 114c—and each sub-compartment may have a corresponding door that serves as a closure for such sub-compartment. In such configurations, opening a door to one sub-compartment enables access only to that sub-compartment, while the remaining sub-compartments remain inaccessible.

In an embodiment of the invention, door panel 502 may comprise a translucent or transparent panel that enables a user or purchaser to view articles stored within an interior compartment or sub-compartment. In another embodiment, door panel 502 may comprise an opaque panel with illustrations or photographic representations of articles stored within an interior compartment or sub-compartment. In another embodiment, door panel 502 may comprise a CRT, or an LCD or plasma panel or other panel capable of displaying photographs, illustrations or videos thereon—which can be used to display representations of articles stored within an interior compartment or sub-compartment.

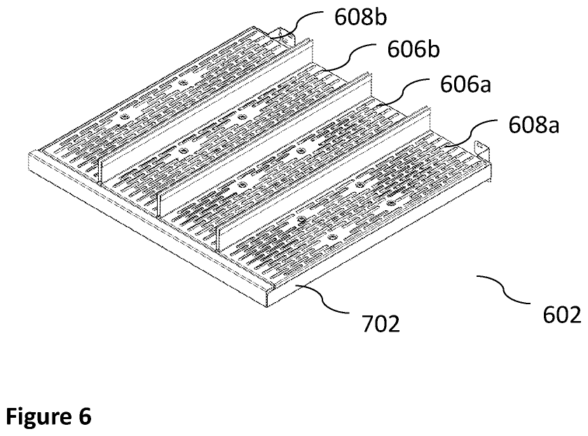

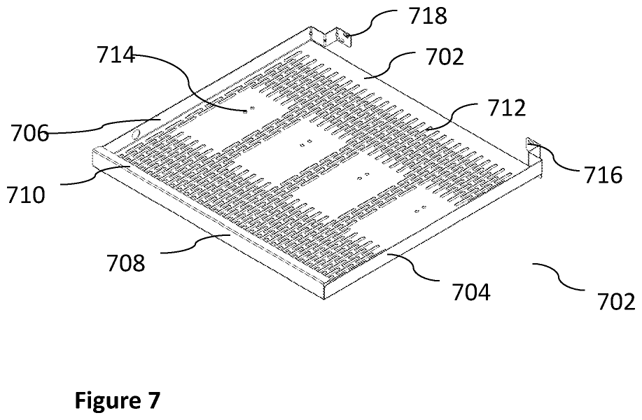

FIG. 6 illustrates an embodiment 602 of horizontal partition 114a of a type that that may be used for sub-compartmentalization and storage within vending machine 100. In the illustrated embodiment the horizontal partition consists of a partition chassis 602, said partition chassis including at least one base plate 702 and at least one (and preferably a plurality of) partition tray(s) 606a, 608a, 608b and 606b mounted independent of (and in isolation from) each other on said base plate 702. As illustrated in more detail in FIG. 7, base plate 702 is a rectangular base plate 702 with flanges 704, 706 and 708 located at the periphery of base plate 702. Flanges 704 and 706 are located on respective side edges of base plate 702, while flange 708 is located at a front edge of base plate 702. Flange 708 may additionally include a lip 710, which lip 710 is substantially perpendicular to flange 708. Base plate 702 may additionally include wall plates 716 and 718 which may be used to affix base plate 702 to an internal surface of a rear sidewall (i.e. the sidewall opposite the opening) of cabinet 102. Partition chassis 602 may in an embodiment be sized and configured such that it can be inserted or slotted into vending cabinet 102 and supported in a desired position either by support members such as support members 116, 116′ or by virtue of one or more fasteners including without limitation screws, bolts, lugs or rivets.

Base plate 702 of partition chassis 602 includes a plurality of holes or perforations 712. Said holes or perforations enable circulation of air throughout cabinet 102—which is particularly advantageous in temperature and/or climate controlled cabinets. Base plate 702 may additionally be provided with one or more holes sized to accept mounting fasteners such as bolts, screws or rivets—the purpose of which mounting fasteners will be discussed subsequently. In an embodiment of the invention Base plate 702 may include (for example on an underside), one or more columns or channels to house and conceal wiring running through the vending machine cabinet. In another embodiment, base plate 702 may be configured to be seated on one or more such columns. In an embodiment of the invention, base plate 702 may additionally be provided with (for example on an underside of the base plate) one or more layers of insulating material (such as for example a styrofoam layer or styrofoam layer) to insulate a vending machine compartment from temperature differentials between said vending machine compartment and one or more adjacent compartments.

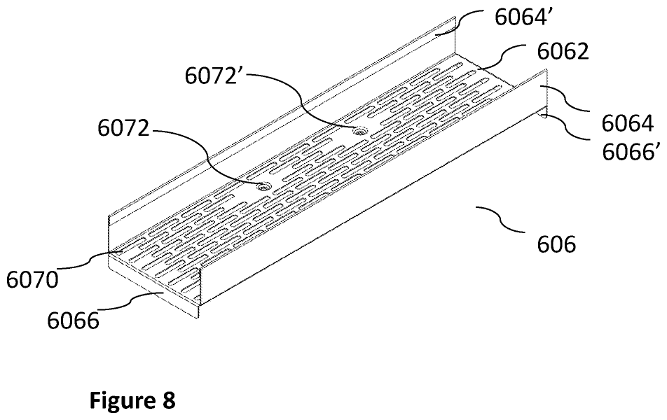

FIG. 8 illustrates an embodiment of partition tray 606—comprising partition tray plate 6062 having a top (upward) surface and a bottom (downward) surface. Partition tray plate 6062 is provided with flanges 6064 and 6064′ on two opposite side edges of plate 6062 (preferably on the two longer edges), which flanges protrude from a first surface of partition tray plate 6062 in a direction substantially perpendicular to partition tray plate 6062. As will be described in more detail subsequently, flanges 6064 and 6064′ serve as sidewalls for partition tray plate 6062—and prevent articles that are placed on partition tray plate 6062 from falling over or from inadvertently being moved partially or wholly onto any adjacent or adjoining partition tray plate. Partition tray plate 6062 may additionally be provided with flanges 6066 and 6066′ on the remaining two edges of partition tray plate 6062 (preferably the two shorter side edges), which flanges protrude from a second surface of plate 6062 (which second surface is opposite to the first surface of plate 6062) in a direction substantially perpendicular to partition tray plate 6062. Flanges 6066 and 6066′ may in various embodiments ensure that partition tray plate 6062 is seated securely within or engages securely with base plate 702.

Partition tray plate 6062 may include a plurality of holes or perforations 6070—which holes or perforations enable circulation of air throughout cabinet 102. Partition plate 6062 may additionally be provided with one or more holes 6072, 6072′ sized to accept mounting fasteners such as bolts, screws or rivets.

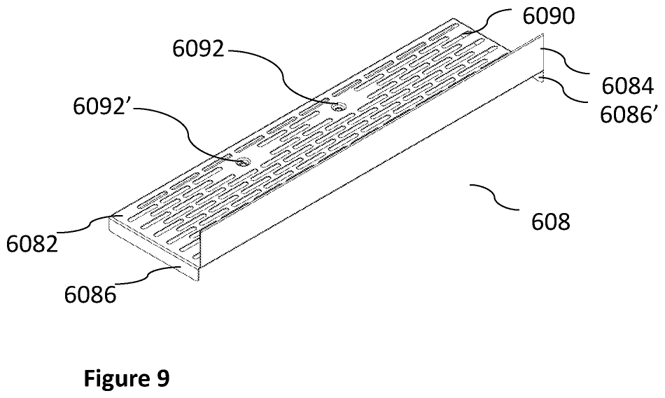

FIG. 9 illustrates an embodiment of partition tray 608—comprising partition tray plate 6082 having a top (upward) surface and a bottom (downward) surface. Partition tray plate 6082 is provided with flange 6084 on one edge of plate 6082 (preferably on one of the two longer edges) which flange protrudes from a first surface of partition tray plate 6082 in a direction substantially perpendicular to partition tray plate 6082. As will be described in more detail subsequently, flange 6084 serves as a sidewall for partition tray plate 6082—and prevents articles that are placed on partition tray plate 6082 from falling over or from inadvertently being moved partially or wholly onto any adjacent or adjoining partition tray plate. Partition tray plate 6082 may additionally be provided with flanges 6086 and 6086′ on two opposite side edges of partition tray plate 6082 (preferably the two shorter side edges), which flanges protrude from a second surface of plate 6082 (which second surface is opposite to the first surface of plate 6082) in a direction substantially perpendicular to partition tray plate 6082. Flanges 6086 and 6086′ may in various embodiments ensure that partition tray plate 6082 is seated securely within or engages securely with base plate 702.

While FIGS. 8 and 9 illustrate different types of partition tray plates that may be simultaneously mounted on a base plate for the purposes of assembling a partition chassis, it would be understood that in certain embodiments, all partition tray plates mounted on a base plate may comprise partition tray plates of the same configuration or type. For example, a partition chassis may comprise a plurality of partition tray plates, all of the type illustrated in FIG. 9 or all of the type illustrated in FIG. 8.

Partition tray plate 6082 may include a plurality of holes or perforations 6090—which holes or perforations enable circulation of air throughout cabinet 102. Partition plate 6082 may additionally be provided with one or more holes 6072, 6072′ sized to accept mounting fasteners such as bolts, screws or rivets.

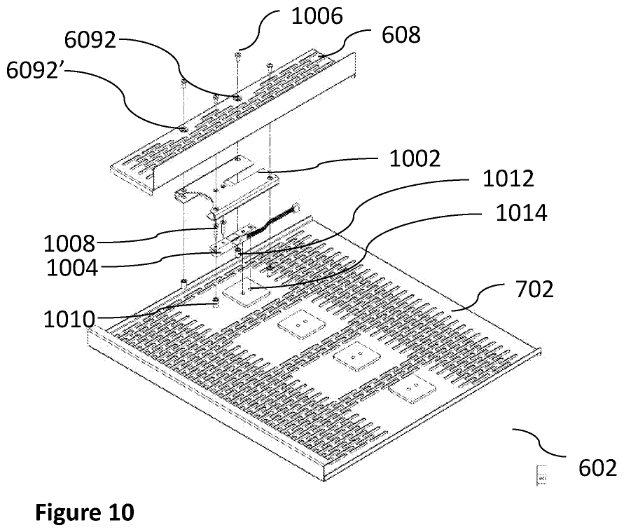

FIG. 10 illustrates an exploded view of a partially assembled partition chassis 602—comprising partition tray 608 mounted on base plate 702. As illustrated in FIG. 10, partition tray 608 is mounted on bracket 1002—which bracket 1002 is in turn coupled to base plate 702 by means of load cell 1004. Bracket 1002 and load cell 1004 will be discussed in more detail below. As illustrated in FIG. 10, partition tray 608 may be mounted on bracket 1002 by means of fasteners 1006, 1010 (e.g. bolts, screws or rivets) passing through one or more holes 6092, 6092′ provided on partition tray 608, and through corresponding holes 1204a to 1204f on bracket 1002. Likewise bracket 1002 may be mounted by means of one or more fasteners 1008 onto load cell 1004. Load cell 1004 may in turn be mounted by means of fasteners 1012 and holes 1014 onto the surface of base plate 702. While in the illustrated embodiment, partition tray 608 is mounted on base plate 702 using a single bracket and single load cell, it would be understood that other embodiments involving multiple brackets or multiple load cells are equally implementable.

It would be understood that the illustration of FIG. 10 is only exemplary, and the partition chassis may comprise either less or more parts than are illustrated in the exploded view. In some embodiments, one or more of the fasteners may be done away with, and one or more of the illustrated component parts may either be welded together or otherwise unitarily integrated with a view to mount one or more partition tray plates on a base plate by means of one or more load cells.

Load cell 1004 may comprise any type of load cell or load sensor capable of detecting and signaling a load state of (i.e. weight/load applied to) the partition tray to which said load cell or load sensor is coupled. Illustrative embodiments of load cell 1004 may comprise load beams, strain gauges and associated electronic or analogue components for signaling a change in load. The load cell or load sensor is mounted between bracket 1002 and base plate 702 such that any change in load/weight placed on partition tray 608 is detected and signaled by load cell 1004. In an embodiment of the invention, load cell 1004 is a single point load cell.

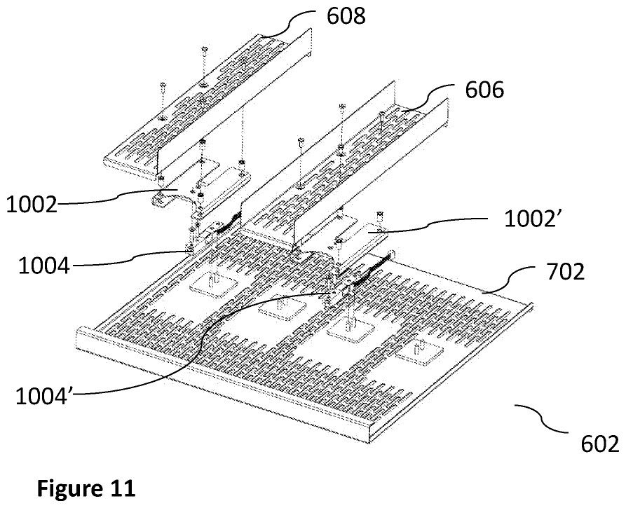

FIG. 11 illustrates another exploded view of a partially assembled partition chassis 602—comprising partition tray 608 and partition tray 606 mounted adjacent to each other on base plate 702. As in the case of FIG. 10, partition tray 608 is mounted on bracket 1002—which bracket 1002 is in turn coupled to base plate 702 by means of load cell 1004. Likewise, partition tray 606 is mounted on bracket 1002′—which bracket is in turn coupled to base plate 702 by means of load cell 1004′. The illustrated configuration ensures that (i) in the case of partition tray 608, any change in load/weight placed on said partition tray is detected and signaled by load cell 1004, and (ii) in case of partition tray 606, any change in load/weight placed on said partition tray is detected and signaled by load cell 1004′.

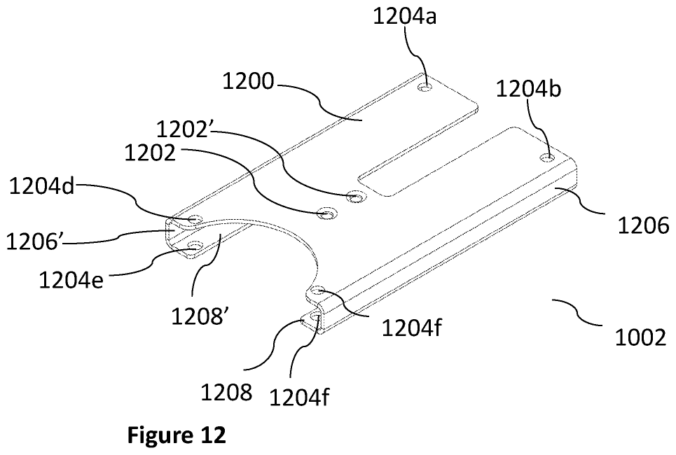

FIG. 12 illustrates an exemplary embodiment of bracket 1002 that may be used to mount partition tray 606, 608 onto base plate 702. Bracket 1002 comprises mounting surface 1200, which mounting surface 1200 engages with a corresponding surface of partition tray 606, 608 for mounting, and which mounting surface 1200 is provided with holes 1204a to 1204d for the purpose of receiving fasteners (bolts, rivets, screws etc.) for securely engaging bracket 1002 with partition tray 606, 608. Mounting surface 1200 may additionally include holes 1202, 1202′ for receiving fasteners for securely engaging bracket 1002 with a load cell 1004, 1004′ when mounted on base tray 702. Bracket 1002 is additionally provided with flanges 1206, 1206′ protruding perpendicularly along opposed side edges of said bracket 1002, with corresponding lips 1208 and 1208′ protruding perpendicularly from said flanges 1206, 1206. In an embodiment, said flange and lip arrangements provide structural strength and/or secure engagement with other components within partition chassis 602. In the illustrated embodiment, bracket 1002 is provide with holes 1204e and 1204f on lips 1208 and 1208′ to receive one or more fasteners.

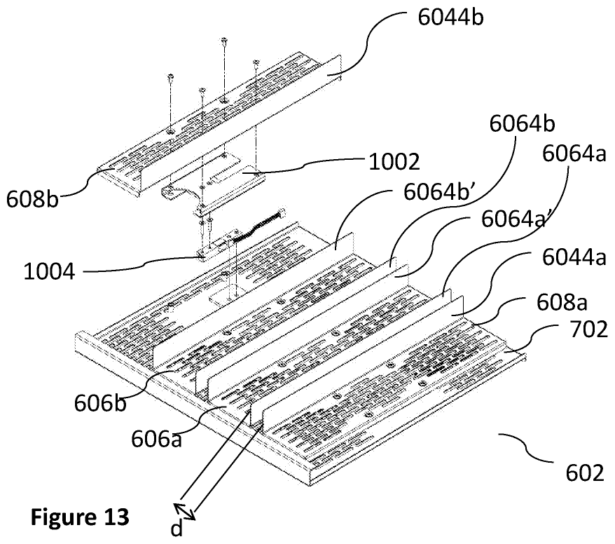

FIG. 13 illustrates a partially exploded view of partition chassis 602, on which four partition trays 608a, 606a, 606b and 608 are mounted. It will be understood from the illustration that partition trays 606a and 606b are of the type previously illustrated and discussed in connection with FIG. 9, while partition trays 608a and 608b are of the type illustrated and discussed in connection with FIG. 8. It will be further understood that in alternate embodiments only a single type of partition tray may be used for all partition trays within partition chassis 602. Additionally, as illustrated in the partially exploded view in FIG. 13, each of the partition trays (for example partition tray 608b) may be mounted onto base tray 702 using bracket 1002 and load cell 1004 in the same manner as previously discussed in connection with FIGS. 10 and 11.

In a specific embodiment of the invention, partition trays 606a, 606b, 608a, 608b are independently mounted within said partition chassis 602 so as to ensure that each partition tray 606a, 606b, 608a and 608b is isolated from contact with any and/or all adjacent partition trays within partition chassis 602. In the illustrated embodiment of FIG. 13, the invention achieves this by ensuring a minimum separation distance between (i) adjacent sidewalls 6064b and 6064a′ of adjacent partition trays 606b and 606a, (ii) adjacent sidewalls 6064a and 6044a of adjacent partition trays 606a and 608a, and/or (iii) adjacent sidewalls 6044b and 6064b′ of adjacent partition trays 608b and 606b. In a preferred embodiment of the invention, said minimum separation distance between adjacent sidewalls of two adjacent partition trays is selected such that the two adjacent partition trays are in contact isolation (i.e. not in contact with each other) when one or both of said partition trays are completely unloaded (i.e. are not supporting any article thereon), partially loaded (i.e. are supporting one or more articles having a combined load/weight that is less than the maximum load/weight that the underlying load cells/load sensors are rated for or are capable of detecting and signaling) and fully loaded (i.e. are supporting one or more articles having a combined load/weight that is equal to the maximum load/weight that the underlying load cells/load sensors are rated for or are capable of detecting and signaling).

By including a plurality of independently mounted partition trays within a single partition chassis, and by ensuring that (i) each independently mounted partition tray has its own corresponding independent load cell/load sensor and that (ii) each independently mounted partition tray within the same partition chassis remains in contact isolation from adjacent partition trays (and from all other partition trays within the partition chassis) in both fully loaded and fully unloaded states—the present invention ensures that if necessary, each partition tray within a partition chassis may be used to store a distinct type of product/article—thereby allowing multiple different product types to be stored on a single horizontal partition of a vending machine, while simultaneously being able to correctly identify a product/article removed from storage on a shelf or horizontal partition or a vending machine, by virtue of pre-programmed associations between product types and trays to which such product types have been assigned. The specific methods of identifying and billing for articles removed from a horizontal partition or shelf within a vending machine are discussed in further detail below.

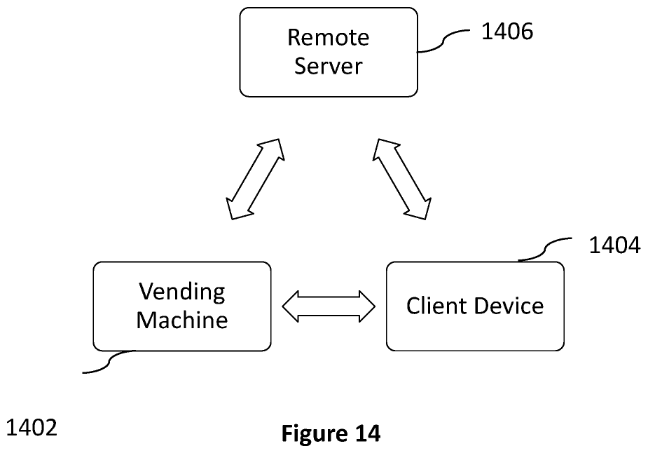

FIG. 14 is a high level communication flow diagram illustrating communications involved in operating a vending machine of the type described hereinabove. In the illustrated embodiment, vending machine 1402 is communicably coupled with remote server 1406. The communication link between vending machine 1402 and remote server 1406 may comprise any wired or wireless communication link. Data communication over the communication link may in an embodiment be achieved by way of any one or more communication protocols, including without limitation, TCP/IP communication protocol or a UDP protocol. The underlying communication network used to implement the communication protocol may include any one or more of local area network, wide area network, broadband network or a combination of the above (such as the internet). It would be understood that in other embodiments of the invention, data communication may be implemented by any electrical, optical or wireless transmission media or link, including by way of example, by one or more of RF, infrared, acoustic, microwave, Bluetooth or other transmission media or link. A customer seeking to operate vending machine 1402 requires access to a client device 1404—which client device 1404 may comprise any client terminal, and in a preferred embodiment is a mobile communication device (such as a tablet, smart phone, mobile phone, phablet or personal digital assistant). Client device 1404 likewise may be communicably coupled with vending machine 1402 as well as with remote server 1406 over independent communication channels—wherein the communication link may once again be implemented by any electrical, optical, RF, infrared, acoustic, microwave, Bluetooth or other transmission media or link. In an alternative embodiment, the client device 1404 may communicate with vending machine 1402 through remote server 1406 (acting as an intermediate server) standard communication methods—for example by means of TCP/IP or UDP based protocols. By virtue of the communication links established between vending machine 1402, client device 1404 and remote server 1406, a customer may operate the vending machine of the present invention in accordance with the methods described hereinbelow.

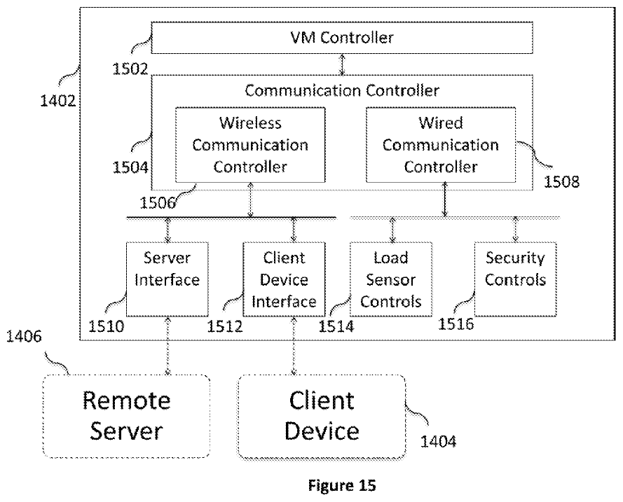

FIG. 15 illustrates control components of vending machine 1402 in detail. In the illustrated embodiment, vending machine 1402 comprises a vending machine (VM) controller 1502 that controls higher level functions and operations of vending machine 1402 through communication controller 1504. Communication controller 1504 comprises (i) wireless communication controller 1506 that is configured to interface, control and/or communicate with devices or components wirelessly, and (ii) wired communication control 1508 that is configured to interface, control and/or communicate with devices or components over a wired connection. Wireless communication controller 1506 communicates with server interface 1510—which service interface 1510 enables remote server 1406 to communicate with vending machine 1402. Wireless communication controller 1506 additionally communicates with client device interface 1512—which client device interface enables client device 1404 to communicate with or operate vending machine 1402 (it will be understood that the communication between client device 1404 and vending machine 1404 may in an embodiment take place through remote server 1406 by virtue of one or more conventional communication protocols such as the TCP/IP or UDP protocol). Wired communication controller 1506 is communicably coupled with load sensor controls 1514(and in an embodiment, with electronic lock controls) to enable VM controller 1502 to receive information regarding load state changes from one or more load cells or load sensors within vending machine 1402. Wired communication controller 1506 is additionally communicably coupled with security controls 1516 such that VM controller 1502 can selectively enable and disable access (for example by engaging or disengaging door locks) to one or more doors of vending machine 1402 with a view to allow and/or terminate access to one or more horizontal partitions within vending machine 1402.

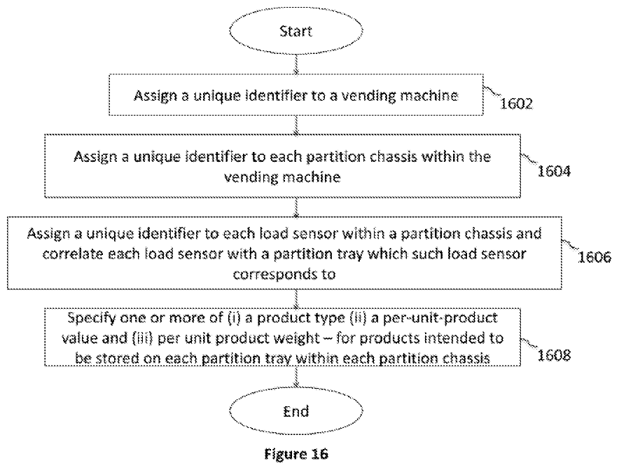

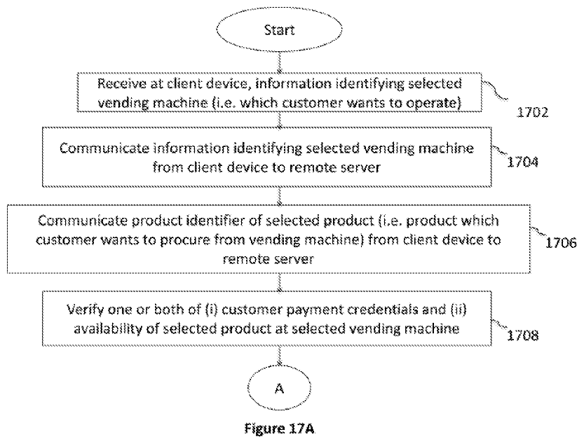

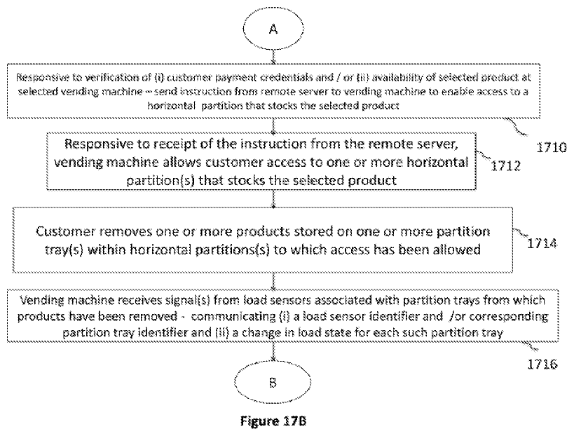

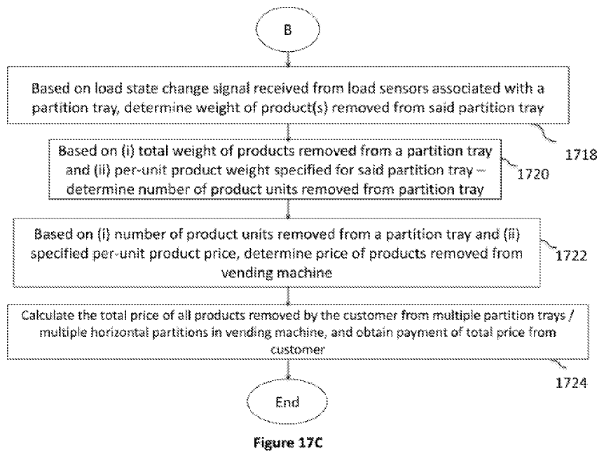

FIGS. 16 and 17A to 17C hereafter describe methods for configuring and operating vending machines of the type illustrated and described in connection with FIG. 15.

FIG. 16 illustrates a method of configuring or preparing a vending machine of the present invention for operational use.

Step 1602 comprises assigning a unique identifier to vending machine 1402. The unique identifier assigned to vending machine 1402 is made available to said vending machine through VM controller 1502, and is also made available to remote server 1406, wherein the remote server uses said unique identifier as a database key to associate information relevant to said vending machine (for example, product inventory, machine status, customer requests received in connection with said vending machine, inventory re-stocking requests, revenue generated by sale of products of the vending machine, specific product types located on specific horizontal partitions or specific partition trays within the vending machine, and information correlating horizontal partitions/partition trays within a vending machine with doors of the vending machine that enable access to said horizontal partitions/partition trays). The unique identifier may be generated and communicated to vending machine 1402 and/or to remote server 1406 in any number of ways that would be immediately apparent to the skilled person. In an embodiment, the unique identifier is generated by remote server 1406 and is communicated to vending machine 1402.

Step 1604 comprises assigning a unique identifier to each partition chassis within the vending machine. Thereafter, step 1606 comprises (i) assigning a unique identifier to each load sensor within a partition chassis and/or each partition tray housed on said partition chassis and (ii) correlating each partition tray with each load sensor that is configured to sense a load state change in said partition tray.

Step 1608 comprises specifying (or recording) for each partition tray, one or more of (i) a product type intended to be stored on the partition tray (ii) a per-unit product value/retail value associated with said product type (iii) a per-unit product weight associated with said product type.

It will be understood that the identifiers and information discussed in connection with steps 1602 will be made available to or recorded at remote server 1406 and/or vending machine 1402.

FIGS. 17A to 17C illustrate a process flow setting out the various steps involved in dispensing products stored within a vending machine of the type contemplated by the present disclosure, and which has been configured in accordance with the disclosure set out in connection with FIG. 16 above.

For the purposes of discussing the method discussed in connection with FIGS. 17A to 17C, an exemplary client device 1404 may comprise a mobile communication device having an Internet or wireless data connection, and having a mobile software application installed thereon—which mobile software application is configured to implement some or all of the steps discussed in connection with FIGS. 17A to 17C. It will however be understood that this is only an exemplary embodiment, and the steps of FIGS. 17A to 17C may be implemented by any client device 1404 having the minimum capabilities that have been discussed previously.

Step 1702 comprises receiving at a client device 1404, information identifying a specific vending machine (i.e. a selected vending machine) from which a customer seeks to obtain a product. By way of example, the client device may receive such information in the form of a vending machine identifier received from the vending machine 1402 in the course of wireless (e.g. Bluetooth) communication with said vending machine (or using TCP/IP/UDP protocols through a remote server), or by way of user input at client device 1404 (based on a vending machine identifier displayed on the vending machine), or by way of an RFID, bar code or other unique identification markings that are displayed on vending machine 1402 and which can be scanned by client device 1404 or by one or more peripherals connected therewith. In an embodiment of the invention, the client device 1404 may send its GPS information(or through other proximity techniques such as Bluetooth beacons) to remote server 1406, and remote server 1406 may respond by sending client device 1404 the vending machine identifier corresponding to a vending machine present at the identified GPS location at which the client device 1404 is located.

Steps 1704 and 1706 comprise communicating from client device 1404 to remote server 1406 (i) information identifying the vending machine 1402 that a customer has selected for product purchase and (ii) a product identifier of at least one product that the customer intends to purchase from vending machine 1402 (i.e. the selected product). The product identifier may in an embodiment correspond to a product that the customer has selected for purchase on the mobile application software.

Step 1708 comprises verifying (i) customer payment credentials (e.g. one or both of payment instruments/mechanisms associated with the customer, and credit available to the customer) and (ii) availability of the selected product at the selected vending machine 1402.

Step 1710 comprises responding to satisfactory verification of (i) customer payment credentials and/or (ii) availability of the selected product at the selected vending machine—by sending a signal from remote server 1406 to vending machine 1402, which signal instructs vending machine 1402 to enable the customer to access a horizontal partition that stocks the selected product. In a specific embodiment, the instruction sent from remote server 1406 may identify one or more of (i) a specific horizontal partition (or partition tray) on which the selected product is available, (ii) a vending machine door that enables/restricts access to the identified horizontal partition (or partition tray).

In an alternative embodiment of step 1710, remote server 1406 may instead send to client device one or more of (i) information identifying a specific horizontal partition (or partition tray) on which the selected product is available, (ii) information identifying a vending machine door that enables/restricts access to the identified horizontal partition (or partition tray) and (iii) one or more unlock codes necessary to instruct vending machine 1402 to unlock the relevant vending machine door. In this alternative embodiment, client device 1404 communicates the received information onward to vending machine 1402 (either directly or through the remote server)—signaling a request to vending machine 1402 for unlocking the relevant vending machine door to enable the customer access to the product stored behind the unlocked door. In a preferred embodiment the unlock codes forwarded to the client device 1404 may comprise encrypted unlock codes or encrypted single-use unlock codes.

Vending machine 1402 receives (either directly from remote server 1406 or through client device 1404) the information discussed in connection with step 1710, analyses the information, and subject to verification that the information received is genuine, may at step 1712 unlock the relevant vending machine door and allow the customer access to horizontal partitions (or partition trays) behind the unlocked vending machine door.

At step 1714, the customer may thereafter remove one or more products stored on one or more of the partition trays (or horizontal partitions) to which said customer has been granted access by unlocking of the vending machine door(s).

Step 1716 comprises receiving at VM controller 1502, signals from load sensor(s) that are coupled with (for example, disposed under) partition trays from which products have been removed by the customer (as step 1714)—which signals communicate (i) a load sensor identifier and/or corresponding partition tray identifier and (ii) information describing a change in load state for each such partition tray. VM controller 1502 may optionally communicate such information to remote server 1406.

At step 1718, based on the load state change signal received from a load sensor associated with a partition tray, a weight of product(s) that has been removed by the customer from said partition tray is calculated. This step may be repeated for each partition tray at which a load state change has been detected.

Step 1720 thereafter comprises using (i) the determined weight of products removed from a partition tray and (ii) a per-unit product weight associated with a product type stored on said partition tray—to determine the specific number of product units that have been removed from a partition tray. This step may be repeated for each partition tray at which a load state change has been detected. Optionally, inventory status of each such partition tray may be updated at VM controller 1502 and/or remote server 1406 to account for the product units that have been removed from a partition tray by a customer.

Step 1722 thereafter comprises using (i) the number of product units removed from a partition tray and (ii) the specified per-unit product price associated with the product type stored on said partition tray—to determine the total price of products removed from the partition tray. This step may be repeated for each partition tray at which a load state change has been detected.

Step 1724 comprises determining the total price of all products removed by a customer from all partition tray(s) or horizontal partition(s) to which the customer has been given access by unlocking of a partition door—which total price is the sum of the prices determined for each partition tray at step 1722. Step 1724 thereafter involves obtaining payment of the total price from the customer—for example by debiting a pre-paid electronic fund account associated with the customer or by charging the customer's bank account or credit or debit card.

In an embodiment of the invention, one or both of steps 1722 and 1724 may be implemented after the vending machine door that has been opened to enable a customer to access and remove products from a horizontal partition/partition tray has been closed or has been closed and locked. In an embodiment of the invention, one or both of steps 1722 and 1724 may be implemented after VM controller 1502 (i) receives a signal from security controls 1516 that a vending machine door has been closed (ii) dispatches an instruction to security controls 1516 to re-engage door lock(s) for one or more vending machine doors or (iii) receives a signal from security controls 1516 that locks for one or more vending machine doors have been re-engaged. In an embodiment of the invention, if the vending machine door does not close, a timer may be activated, wherein the process of securing payment for items removed from the vending machine is initiated after expiry of a predefined time interval from activation of the timer. In an embodiment, activation of the timer and elapse of time from activation of the timer is communicated to the client device by way of one or more alerts.

It will be understood that while the method and vending machine embodiments rely on load cells or other weight sensing mechanisms as one means for identifying products removed from a vending machine, the vending machine may employ other supplementary or alternative means for detecting product removal. In an embodiment, the vending machine cabinet is provided with a camera coupled with a processor configured to implement product recognition algorithms or methods using image or video feeds captured by the camera.

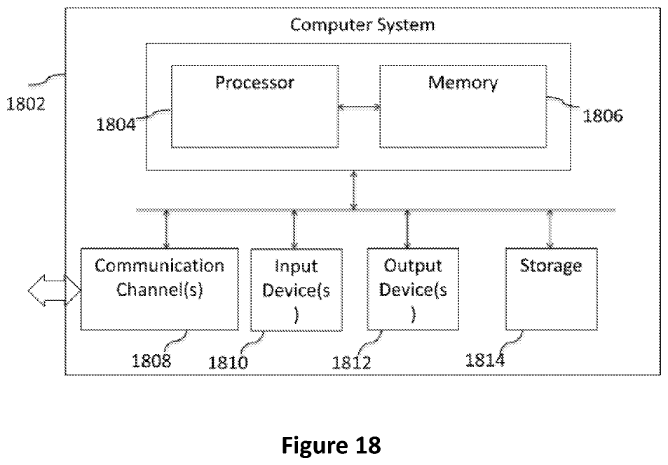

FIG. 18 illustrates an exemplary computing system for implementing the present invention.

The computing system 1802 comprises one or more processors 1804 and at least one memory 1806. Processor 1804 is configured to execute program instructions—and may be a real processor or a virtual processor. It will be understood that computer system 1802 does not suggest any limitation as to scope of use or functionality of described embodiments. The computer system 1802 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a system 1802 in accordance with the present invention may include one or more servers, desktops, laptops, tablets, smart phones, mobile phones, mobile communication devices, tablets, phablets and personal digital assistants. In an embodiment of the present invention, the memory 1806 may store software for implementing various embodiments of the present invention. The computer system 1802 may have additional components. For example, the computer system 1802 may include one or more communication channels 1808, one or more input devices 1810, one or more output devices 1812, and storage 1814. An interconnection mechanism (not shown) such as a bus, controller, or network, interconnects the components of the computer system 1802. In various embodiments of the present invention, operating system software (not shown) provides an operating environment for various softwares executing in the computer system 1802 using a processor 1804, and manages different functionalities of the components of the computer system 1802.

The communication channel(s) 1808 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1810 may include, but is not limited to, a touch screen, a keyboard, mouse, pen, joystick, trackball, a voice device, a scanning device, or any another device that is capable of providing input to the computer system 1802. In an embodiment of the present invention, the input device(s) 1010 may be a sound card or similar device that accepts audio input in analog or digital form. The output device(s) 1812 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1802.

The storage 1814 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1002. In various embodiments of the present invention, the storage 1814 may contain program instructions for implementing any of the described embodiments.

In an embodiment of the present invention, the computer system 1802 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1802. The method described herein is typically implemented as a computer program product, comprising a set of program instructions which is executed by the computer system 1802 or any other similar device. The set of program instructions may be a series of computer readable codes stored on a tangible medium, such as a computer readable storage medium (storage 1814), for example, diskette, CD-ROM, ROM, flash drives or hard disk, or transmittable to the computer system 1802, via a modem or other interface device, over either a tangible medium, including but not limited to optical or analogue communications channel(s) 1808. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

It will be understood that methods and systems in accordance with the present invention provide an efficient and effective solution to the need for vending machines that simplify the user experience and present manufacturing and cost efficiencies, while simultaneously ensuring an efficient and secure payment system. Additionally, by incorporating a purchase and payment solution into mobile communication devices, users no longer need to have cash or electronic cards available to effect a purchase—and can instead rely entirely on their mobile phone.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A vending machine comprising:
a vending machine cabinet having an interior compartment;
at least one horizontally oriented partition chassis configured to sub-compartmentalize the interior compartment into a plurality of sub-compartments, wherein the partition chassis comprises:
a base plate;
a plurality of partition trays independently mounted on said base plate, wherein each partition tray is mounted on the base plate in contact isolation from all other partition trays mounted on said base plate;
a plurality of load sensors, wherein:
each load sensor corresponds uniquely to one partition tray mounted on the base plate; and
each load sensor is configured to detect and signal changes in load state associated with its corresponding partition tray;
at least one door having a selectively actuatable lock, said door providing access to the at least one horizontally oriented partition chassis; and
a controller configured to determine weight of product(s) removed from a partition tray based on signals received from load sensors corresponding to said partition tray.

2. The vending machine as claimed in claim 1, wherein:
the controller is communicably coupled with at least one of a remote server and a client device; and
the controller is configured to receive from either one of the remote server and the client device, one or more of:
i) a product identifier corresponding to at least one product selected for purchase by a customer;
ii) identifier(s) corresponding to at least one partition chassis on which the selected product is stored or at least one partition tray on which the selected product is stored within the vending machine cabinet;
iii) identifier(s) corresponding to a vending machine door that controls access to a partition chassis or partition tray on which the selected product is stored within the vending machine cabinet; and
iv) code(s) authorizing unlocking of one or more vending machine doors that control access to a partition chassis or partition tray on which the selected product is stored within the vending machine cabinet.

3. The vending machine as claimed in claim 1, wherein the controller is configured to determine weight of product(s) removed from a partition tray, for each partition tray where load state changes have been detected by corresponding load sensors.

4. The vending machine as claimed in claim 1, wherein the controller is configured to determine a total price of product(s) removed by a customer based on:
i) weight of product(s) removed from partition trays where load state changes have been detected;
ii) per-unit product weight associated with said partition trays; and
iii) per-unit product price associated with product types stored on said partition trays.

5. The vending machine as claimed in claim 4, wherein the total price of product(s) removed by a customer is determined in response to a trigger event, said trigger event comprising any one of:
(i) receiving a signal confirming that a vending machine door has been closed;
(ii) sending of a signal to re-engage door lock(s) for one or more vending machine doors; or
(iii) receiving a signal confirming that locks for one or more vending machine doors have been re-engaged.

6. An automated product dispensing system comprising:
a remote server; and
a vending machine comprising:
a vending machine cabinet having an interior compartment;
at least one horizontally oriented partition chassis configured to sub-compartmentalize the interior compartment into a plurality of sub-compartments, wherein the partition chassis comprises:
a base plate;
a plurality of partition trays independently mounted on said base plate, wherein each partition tray is mounted on the base plate in contact isolation from all other partition trays mounted on said base plate;
a plurality of load sensors, wherein:
each load sensor corresponds uniquely to one partition tray mounted on the base plate; and
each load sensor is configured to detect a load state associated with its corresponding partition tray;
at least one door having a selectively actuatable lock, said door providing access to the at least one horizontally oriented partition chassis; and
a controller configured to determine weight of product(s) removed from a partition tray based on signals received from load sensors corresponding to said partition tray;
wherein the remote server and the controller are communicably coupled to each other.

7. The automated product dispensing system as claimed in claim 6, wherein the remote server is configured to record one or more of:
i) a unique identifier corresponding to the vending machine;
ii) unique identifiers corresponding to each load sensor or each partition tray mounted within the at least one partition chassis;
iii) a correlation between each load sensor with a corresponding partition tray;
iv) a product type associated with each partition tray within the at least one partition chassis;
v) a per-unit product weight associated with each recorded product type; and
vi) a per-unit product price associated with each recorded product type.

8. The automated product dispensing system as claimed in claim 6, wherein:
at least one of the remote server and the controller are configured for wireless communication with a client device; and
the controller is configured to receive from either one of the remote server and the client device, one or more of:
i) a product identifier corresponding to at least one product selected for purchase by a customer;
ii) identifier(s) corresponding to at least one partition chassis on which the selected product is stored or at least one partition tray on which the selected product is stored within the vending machine cabinet;
iii) identifier(s) corresponding to a vending machine door that controls access to a partition chassis or partition tray on which the selected product is stored within the vending machine cabinet; and
iv) code(s) authorizing unlocking of one or more vending machine doors that control access to a partition chassis or partition tray on which the selected product is stored within the vending machine cabinet;

9. The automated product dispensing system as claimed in claim 6, wherein the controller is configured to determine weight of product(s) removed from a partition tray, for each partition tray where load state changes have been detected by corresponding load sensors.

10. The automated product dispensing system as claimed in claim 6, wherein remote server or the controller is configured to determine a total price of product(s) removed by a customer based on:
i) weight of product(s) removed from partition trays where load state changes have been detected;
ii) per-unit product weight associated with said partition trays; and
iii) per-unit product price associated with product types stored on said partition trays.

11. The automated product dispensing system as claimed in claim 10, wherein the total price of product(s) removed by a customer is determined in response to a trigger event, said trigger event comprising any one of:
(i) receiving a signal confirming that a vending machine door has been closed;
(ii) sending of a signal to re-engage door lock(s) for one or more vending machine doors; or
(iii) receiving a signal confirming that locks for one or more vending machine doors have been re-engaged.
